(19) United States
(12) Patent Application Publication
(10) Pub. No.: US 2025/0311055 A1
(43) Pub. Date: Oct. 2, 2025

(54) METHOD FOR SENDING AT LEAST ONE BROADCAST MESSAGE VIA A CENTRAL UNIT IN A VEHICLE, CENTRAL UNIT FOR SENDING A BROADCAST MESSAGE, AND VEHICLE COMPRISING A CENTRAL UNIT

(71) Applicant: Continental Automotive Technologies GmbH, Hannover (DE)

(72) Inventors: Michael Rolf Meitzner, Brigachtal (DE); Stefan Bitzer, Albstadt (DE)

(73) Assignee: Continental Automotive Technologies GmbH, Hannover (DE)

(21) Appl. No.: 19/084,358

(22) Filed: Mar. 19, 2025

(30) Foreign Application Priority Data
Mar. 26, 2024 (DE) 10 2024 108 567.3

(51) Int. Cl. H04W 76/50; G08B 21/02; H04W 4/021; H04W 72/30; H04W 76/40

(52) U.S. Cl. CPC H04W 76/50; G08B 21/02; H04W 72/30; H04W 76/40; H04W 4/021

(57) ABSTRACT

A method for sending at least one broadcast message via a central unit in a vehicle, wherein the broadcast message is intended for multiple audio output units, wherein at least two of the audio output units render different auditory entertainment content that is independent of the central unit is disclosed. The respective audio output unit comprises at least one broadcast radio receiver configured to render auditory content, and for the central unit to receive a predefined emergency signal signaling an emergency event. The central unit broadcasts the at least one broadcast message via at least one radio connection to the respective broadcast radio receiver, wherein the broadcast message comprises the auditory content, and the broadcast message is received by all broadcast radio receivers within a reception area of the central unit, such that all audio output units within the reception area render the auditory content of the broadcast message.

### CROSS REFERENCE TO RELATED APPLICATIONS

This US patent application claims the benefit of German patent application No. 10 2024 108 567.3, filed Mar. 26, 2024, which is hereby incorporated by reference.

### TECHNICAL FIELD

The disclosure relates to a method for sending at least one broadcast message via a central unit in a vehicle, to a central unit configured to send a broadcast message, and to a vehicle comprising at least one central unit.

If an emergency event occurs, new vehicles, in particular vehicles belonging to the vehicle class also including passenger cars, are equipped with automatic emergency call systems, known as eCall systems. When an emergency event occurs, or at least when an emergency event is detected by a unit in the vehicle, said systems transmit information to a rescue coordination center over the mobile network and, also over the mobile network, establish a voice connection to a rescue coordination center.

In addition or as an alternative, it is helpful to directly inform people in an immediate surrounding area, so that they are able to be made aware of the emergency event. The surrounding area may be distinguished, for example in the form of a reception area, by a predefinable maximum distance from the location of the emergency event, in particular by a predefinable maximum distance from the central unit. By way of example, a horn signal may thus be output. This offers the advantage that these people are quicker to the location of the accident than the units despatched by the rescue coordination center, and may for example provide first aid.

One way to inform people in the surroundings is known from EP 3 311 626 B1. That document discloses a communication device by way of which speech is transmitted in the form of audio data from a large number of devices to another device, the audio data are mixed and these mixed audio data are then transmitted to a user. There is no provision for direct transmission from the large number of devices to the user.

KR 101 998 153 B1 describes a system comprising an intercom that is connected to devices via Bluetooth.

US 2020 014 416 A1 describes a communication system for communication over at least two independent radio networks, wherein emergency messages are however transmitted only to members in a predefinable group via an emergency button.

DE 10 2009 015 513 A1 describes an emergency call unit for a vehicle, which has a transmission unit for transmitting a positioning signal to a rescue team multiple times.

### SUMMARY

The disclosure is based on the object of providing a method and/or a system by way of which people in a nearby surrounding area are informed about an emergency event.

The object is achieved by the subjects of the independent patent claims. Advantageous developments of the invention are described by the dependent patent claims, the following description and the figures.

The disclosure relates to a method for sending at least one broadcast message via a central unit in a vehicle, wherein the broadcast message is intended for multiple audio output units, wherein at least two of the audio output units render different auditory entertainment content that is independent of the central unit. The auditory entertainment content is preferably transmitted to the respective audio output unit by a source other than the central unit, wherein different audio output units are able to receive the auditory entertainment content in each case from different sources. This means that not every audio output unit receives or has to (but may) receive the auditory entertainment content to be respectively output from the same source, meaning that the auditory entertainment content of different audio output units may differ.

The auditory entertainment content is for example information content, audio books, film scores, music, radio and/or telephone calls. The audio output units are for example headsets, loudspeakers or headphones. The at least one person who is associated with the audio output unit, that is to say for example the person wearing the headset on their head or generally picking up the sound waves output by the audio output unit, is referred to as a recipient. In particular, the auditory entertainment content may be influenced by the recipient.

According to the disclosure, the respective audio output unit that is used is one that comprises at least one broadcast radio receiver and that is configured to render auditory content, if this is picked up via or from the at least one broadcast receiver, via sound waves. If the central unit receives a predefined emergency signal signaling an emergency event, the central unit broadcasts at least one broadcast message via at least one radio connection to the respective broadcast radio receiver, wherein the broadcast message is distinguished in that it comprises said auditory content, and the broadcast message is received by all broadcast radio receivers within a reception area of the central unit, such that all audio output units within the reception area render the auditory content of the broadcast message. A “reception area” is understood to mean the surrounding area in which the broadcast message broadcast by the central unit is configured to be received by a broadcast radio receiver or in which a radio connection is accepted or the area that is characterized by a predefinable maximum distance from the central unit, as is explained in more detail below.

This means that, when a predefined emergency signal is received by the central unit, a radio connection is established to the respective broadcast radio receivers of all audio output units in the reception area, the broadcast message is broadcast from the central unit, is received by all broadcast radio receivers within the reception area, and the auditory content is output by each of the audio output units. In particular, all of the audio output units render the same auditory content. Provision may be made for example to use GPS (Global Positioning System) and/or MNO (mobile network operator) to determine the country in which the central unit and/or the audio output unit is located, and to render the auditory content in at least one language associated with the respective country. For example, the rendering of the auditory entertainment content is interrupted to render the auditory content. In particular, the rendering of the auditory entertainment content is interrupted when establishment of the radio connection between the audio output unit and the central unit is complete. Provision may be made for the auditory entertainment content to continue being rendered after the auditory content has been rendered.

The reception area may be defined for example by a predefinable maximum distance between the central unit and the respective audio output unit, that is to say all audio output units whose distance from the central unit does not exceed a predefinable distance render the auditory content of the broadcast message in the occurrence of an emergency event. By way of example, this predefinable distance may be 50 m, 100 m, 250 m, 500 m, 750 m or 1 km, that is to say the value of the predefinable distance that indicates the maximum distance between the central unit and the audio output unit may be in a range of 50 m to 1 km. In addition or as an alternative thereto, the reception area may correspond to a pick-up area, that is to say the area in which it is possible to establish the radio connection between the central unit and the audio output unit due to the range of the radio connection. By way of example, the range of the radio connection may be between 0 m and 500 m or between 0 m and 1000 m, wherein the range may be affected by interfering factors such as obstacles.

People within the reception area are informed about the emergency event, meaning that people, who preferably provide assistance, reach the location of the emergency event more quickly than if only a rescue coordination center were informed, which sends out units accordingly. This makes it possible to provide assistance more quickly when an emergency event occurs, since in particular anyone with a driver's license has at least basic knowledge of first aid, and/or people at the location and who have already witnessed the emergency event are able to describe the emergency event more quickly to the units despatched by the rescue coordination center, meaning that units despatched by the rescue coordination center are able for example to find the location of the emergency event more easily and/or are able to help a person at the location of the emergency event more quickly. In particular in the event that the central unit is present in a first motorcycle with a first motorcyclist, this may result in the advantage that other motorcyclists riding with the first motorcyclist in a group are informed if an emergency event occurs with the first motorcyclist. This is particularly advantageous if there is no visual contact between the first motorcyclist and at least one other motorcyclist in the group, for example because the first motorcyclist is riding at the end of the group.

An emergency event may be for example an accident, in particular an accident involving a vehicle preferably in a vehicle class not belonging to the vehicle class that also includes cars, that is to say for example a motorcycle accident, or for example an accident involving a person who carries around a trigger that transmits the predefined emergency signal to the central unit when it is actuated. The person may be for example a person doing work who is located in the surroundings of the vehicle containing the central unit to which the trigger is connected, for example via a radio connection. By way of example, the surroundings may be the area within which the connection between the trigger and the central unit is able to be maintained. By way of example, the person may be a forestry worker who is carrying out appropriate forestry work in the surroundings of a vehicle.

For example, the emergency event is an event in which at least one person suffers harm, for example in the form of an injury, in particular to their body and/or their health.

The disclosure also encompasses developments that result in additional advantages.

One development comprises the central unit establishing the respective radio connection via Bluetooth LE, broadcasting the broadcast message via LE Audio in the form of LE Audio signals and the at least one broadcast receiver receiving the LE Audio signals. Here, Bluetooth LE stands for Bluetooth Low Energy and has the advantage of not requiring a mobile network connection. This circumvents the problem of there having to be sufficient network coverage to transmit the fact that an emergency event has occurred over a mobile network connection. However, this is not yet the case everywhere, meaning that, in corresponding cases, it is first necessary to travel a certain distance from the location of the emergency event so that other people and/or a rescue coordination center are informed about the emergency event, meaning that vital time may be wasted. In contrast, many headsets and headphones nowadays already have at least one Bluetooth LE module for receiving and broadcasting signals via Bluetooth LE. In addition, Bluetooth LE in accordance with standard 5.2 or newer integrates a function that allows a signal to be broadcast from a first device to other devices that are at a predefinable distance from the first device but are not necessarily coupled with the respective other device before the signal is broadcast. The technical requirements are thus already met when using Bluetooth LE. The maximum distance over which it is possible to send a signal via Bluetooth LE may be up to 1000 m.

One development comprises the radio connection between the central unit and at least one broadcast receiver being established only in response to the detection of the emergency event. This means that, prior to the detection of the emergency event, there was no radio connection between the central unit and the at least one broadcast receiver. A distinction is preferably made between the audio output units of recipients and of people involved in the emergency event. People involved in the emergency event may be characterized in that they are located in the reception area and are involved in the emergency event, for example by virtue of having suffered at least one injury, in particular an injury to their body and/or their health, as a result of the emergency event. The other people in the reception area who pick up the sound waves emitted by at least one audio output unit may be referred to as recipients. For example, the at least one audio output unit is connected only to at least one source (for auditory entertainment content) other than the central unit prior to the detection of the emergency event, whereas the at least one audio output unit of a person involved in the emergency event may be connected only to at least one source other than the central unit, only to the central unit or to both. When the emergency event is detected, a radio connection is established between all audio output units in the reception area.

This procedure has the advantage that there did not have to be any connection, for example any radio connection, between the central unit and the respective audio output units prior to the emergency event, meaning that the broadcast message is transmitted to all audio output units in the reception area. The auditory content is thereby communicated to as many people as possible in the reception area. This in particular increases the likelihood of the auditory content being picked up by a person who has first aid knowledge and is able to help a person involved in the emergency event until units despatched by the emergency coordination center arrive at the location of the emergency event.

One development comprises at least one of the following events being signaled as the respective emergency event: (1) An accident detection system detecting an accident. A vehicle and/or mobile device, for example a smartphone and/or a smartwatch, may detect, as is known from the prior art, based on input data, for example noise and/or sensor data, whether an emergency event has occurred. On this basis, an emergency event may be detected. (2) The central unit picking up a predefinable voice command. The predefinable voice command may in particular depend on the country in which the central unit is located. This means that the central unit is able for example to use GPS and/or MNO to determine the country in which it is located. Depending on the determined country, the predefinable voice command may be a voice command in at least one language associated with the respective country. In addition or as an alternative thereto, the voice command may be made in a predefinable, in particular settable language. The fact that the predefinable voice command is picked up by the central unit is particularly advantageous when the central unit is connected to a headset or a microphone. A person involved in the emergency event, provided that they have not fainted, may issue a predefinable voice command that is picked up by a microphone connected to the central unit. For example, the voice command is defined beforehand. This may be done through a predefinable selection of possible voice commands or by a voice command set individually by a person. (3) Absence of transmission of a predefinable signal, for example the absence of capturing of repeated utterance of at least one predefinable word, breathing sounds and/or the actuation of a button or switch, wherein the predefinable signal has to be transmitted at predefinable dead-man time intervals and/or continuously to prevent triggering of the emergency signal. A predefinable signal has to be transmitted continuously or at predefinable dead-man time intervals. By way of example, a predefinable noise has to be picked up continuously or at predefinable dead-man time intervals by a predefinable microphone, or a predefinable switch or button has to be actuated continuously or at predefinable dead-man time intervals, for example by using a dead-man's handle. If this does not happen or no longer happens, this may be interpreted as an emergency event. (4) Exceedance of a predefinable distance between a signal transmitter linked to a position of a person and the central unit. If a person moves away from the central unit, for example a motorcyclist moves away from their motorcycle or a worker moves away from a vehicle provided for work, this may indicate an accident involving the worker, and it is therefore reasonable to assume an emergency event in such cases unless indicated otherwise. In particular, the detection of the exceedance of a predefinable distance may be combined with the detection of a change in acceleration. This means that, in addition to the distance, the change in acceleration of the central unit and/or the person and/or the signal transmitter is captured. For this purpose, for example, the central unit and/or the vehicle comprising the central unit and/or the signal transmitter may have an acceleration sensor. This has the advantage of preventing false alarms triggered by a person moving away from the central unit, for example, if the sending of a broadcast message has not been deactivated beforehand.

These types of detection have the advantage that it is possible to respond automatically to an emergency event and/or the transmission of the fact that an emergency event has occurred is able to be triggered easily by a person involved in the emergency event.

One development comprises the broadcast message comprising predefinable text, which may for example be selected from a selection of texts or be created individually by a person and/or audio signals from a microphone connected to the central unit, the connection possibly being for example a radio connection or a cable, and/or a predefinable tone or a predefinable sequence of tones.

The use of a combination of at least two of the listed features, for example a predefinable tone or a predefinable sequence of tones, followed by a predefinable text or audio signals recorded by a microphone, is particularly advantageous. The recipient is warned beforehand that a message is imminent. The text has the advantage that it is possible to transmit individual information, in particular information important for a unit sent out by the rescue coordination center, for example pre-existing conditions, allergies, intolerances, information about medication intake, blood type or possible contact people. In the case of audio signals, the advantage arises that it is possible to directly transmit important information about the emergency event, for example, a person is able to describe the location of the emergency event more precisely, describe the injuries, or pass on information as in the predefinable text. The predefinable tone or the predefinable sequence of tones has the advantage that, for example, in the same way as warnings, people who pick up the auditory content, for example via a characteristic tone or a characteristic sequence of tones, are informed directly that an emergency event has taken place, as is also the case for example with warning sirens in the event of a disaster.

One development comprises the central unit broadcasting the broadcast message once or periodically at a predefinable time interval, wherein the central unit interrupts or terminates the broadcasting of the broadcast message upon a predefinable command. The predefinable time interval is for example settable and/or depends on the length of the auditory content. By way of example, if the auditory content has the length x, wherein x may be specified for example in seconds or minutes, then the predefinable time interval may be a multiple of x. This has the advantage of being able to ensure that the auditory content has already been rendered completely by the audio output units before the auditory content is rendered again from the beginning.

The predefinable command for termination or interruption may be for example a predefinable voice command, a predefinable noise such as for example a siren of an emergency vehicle, or a signal transmitted over a radio connection. By way of example, a unit despatched by the rescue coordination center may have a deactivation device that terminates or interrupts the broadcast message when the distance between the deactivation device and the central unit falls below a predefinable distance. This and/or the recognition of a predefinable noise offer the advantage that, when a unit despatched by the rescue coordination center arrives, appropriate specialist personnel are on site, meaning that no further repetition of the auditory content is necessary to inform people about the emergency event so that they provide assistance until appropriate specialist personnel arrive. In addition or as an alternative, the option of terminating or interrupting the broadcast message, in particular by way of a voice command, may provide an effective way to interrupt the broadcasting of the broadcast message in the event that an emergency event was detected incorrectly.

One development comprises the broadcast message being broadcast regardless of the presence of a mobile network. This means that a broadcast message is broadcast and is able to be received by broadcast receivers even in areas where there is no mobile coverage (network coverage). This may be useful, on the one hand, for example, if at least one mobile network mast fails due to at least one disaster, for example a flood, a storm and/or a bad weather event or due to vandalism and/or if traveling in an area with poor mobile coverage. The latter may for example be due to the fact that 4G and 5G, although they are able to transmit larger data volumes in the same time than 2G, have less coverage and thus, if 2G is switched off in areas where mobile coverage was present, mobile coverage will no longer be available after 2G is switched off. The advantage is thus that of greater usability, which may also be due to the fact that many headsets and headphones already have the Bluetooth LE function.

One development comprises, when the emergency signal is picked up by the central unit, the central unit outputting an auditory and/or haptic and/or visual trigger signal, wherein the trigger signal is distinguished in that it is picked up by a person in a trigger pick-up area, wherein the trigger pick-up area may be smaller than the reception area, and the broadcast message is broadcast by the central pick-up unit only after a predefinable duration from the outputting of the trigger signal. In other words, when an emergency event is detected, a trigger signal is preferably output for a predefinable duration before the broadcast message is broadcast. By way of example, the predefinable duration may be a duration of up to 0 s, at most 2 s, at most 3 s, at most 5 s or at most 10 s. The trigger signal may be for example a beep, a light signal, a vibration and/or a spoken text.

For example, the trigger signal is such that all people in a predefinable trigger pick-up area have the possibility of perceiving this trigger signal. This means for example that the volume and/or brightness is such that a predefinable minimum brightness and/or minimum volume is not fallen below anywhere within the trigger pick-up area. The trigger pick-up area may be defined for example by a predefinable maximum distance from the central unit, that is to say the trigger pick-up area in this case is the area in which the distance from the central unit does not exceed a predefinable maximum distance. For example, in the case of an emergency event being detected when a predefinable distance is exceeded, the predefinable maximum distance for the trigger pick-up area is greater than the predefinable distance for triggering the emergency event and/or smaller than the predefinable distance for triggering the emergency event plus 10 m, in particular 8 m, preferably 5 m. The predefinable maximum distance may be for example 10 m, 8 m, 5 m, 3 m, 2 m or 1 m. Generally speaking, the value of the maximum distance may be selected in a range of 0.5 m to 10 m.

The procedure has the advantage that a person in the trigger pick-up area is able to be warned beforehand that a broadcast message is being broadcast. This makes it possible to respond before the broadcast message is broadcast. In particular in combination with the option of the broadcasting of a broadcast message being able to be terminated or interrupted, preferably even before the broadcast message is broadcast, that is to say while the trigger signal is being broadcast, it is possible to respond to incorrect recognition of an emergency event, that is to say it is possible to respond if an emergency event has been detected incorrectly, preferably by terminating or interrupting the broadcast message. Since this termination or the interruption of the broadcast message is particularly advantageous in the event of an incorrectly identified emergency event, if the broadcast message has not yet been broadcast, a predefinable duration until the broadcasting of the broadcast message from the detection of the emergency event is useful, meaning that there is time to respond and, in particular, it is possible to prevent broadcasting of the broadcast message.

One development comprises the respective audio output unit comprising a memory that stores a second broadcast message when at least part of a first broadcast message and at least part of the second broadcast message is received at the same time by the at least one broadcast receiver, wherein the start of the second broadcast message is received at a time after the start of the first broadcast message and the stored second broadcast message is rendered after the end of the first broadcast message. This means that, if at least one broadcast receiver receives two broadcast messages at the same time, the second broadcast message is stored in the memory and, after the end of the rendering of the auditory content of the first broadcast message, the auditory content of the second broadcast message is read from the memory and output. At the same time in this case means that the second broadcast message is received while the first broadcast message is being received by the broadcast receiver and the auditory content of the first broadcast message is being rendered by the audio output device. Since, preferably, two broadcast messages are not rendered simultaneously by an audio output device, it is advantageous to save the second broadcast message and then render it when the auditory content of the first broadcast message has been rendered. This also provides an advantageous solution in the event that at least parts of at least two broadcast messages are received at the same time by a broadcast receiver.

For example, in the event that at least one broadcast message is received by a broadcast receiver of an audio output unit while the auditory content of another broadcast message is already being rendered by this audio output unit, the at least one broadcast message that is not rendered due to the rendering of another broadcast message is saved in a memory and/or in the memory.

As a further aspect, the disclosure comprises a central unit configured to send a broadcast message in accordance with the method according to the disclosure.

As a further aspect, the disclosure comprises a vehicle comprising a central unit. For example, the vehicle is a single-track vehicle, in particular a motorcycle.

The disclosure also includes developments of the central unit according to the disclosure and of the vehicle according to the disclosure having features as have already been described in connection with the developments of the method according to the disclosure. For this reason, the corresponding developments of the central unit according to the disclosure and the motor vehicle according to the disclosure are not described again here.

For use cases or application situations that may arise in the method and are not explicitly described here, provision may be made for an error message and/or a request for input of user feedback to be output according to the method and/or for a default setting and/or a predetermined initial state to be set.

The disclosure also includes the combinations of the features of the embodiments described.

### BRIEF DESCRIPTION OF THE DRAWINGS

One embodiment of the disclosure is described below. In the figures:

FIG. 1 shows one embodiment of the method according to the disclosure;

FIG. 2 shows a schematic embodiment of the method according to the disclosure.

### DETAILED DESCRIPTION

The embodiment explained below is an embodiment of the disclosure. In the embodiment, the described components of the embodiment each constitute individual features of the disclosure that should be considered independently of one another, that each also develop the disclosure independently of one another and that should thus also be considered to be part of the disclosure individually or in a combination other than that shown. Furthermore, the embodiment described may also be supplemented by further features of the disclosure that have already been described.

In the figures, functionally identical elements are each provided with the same reference signs.

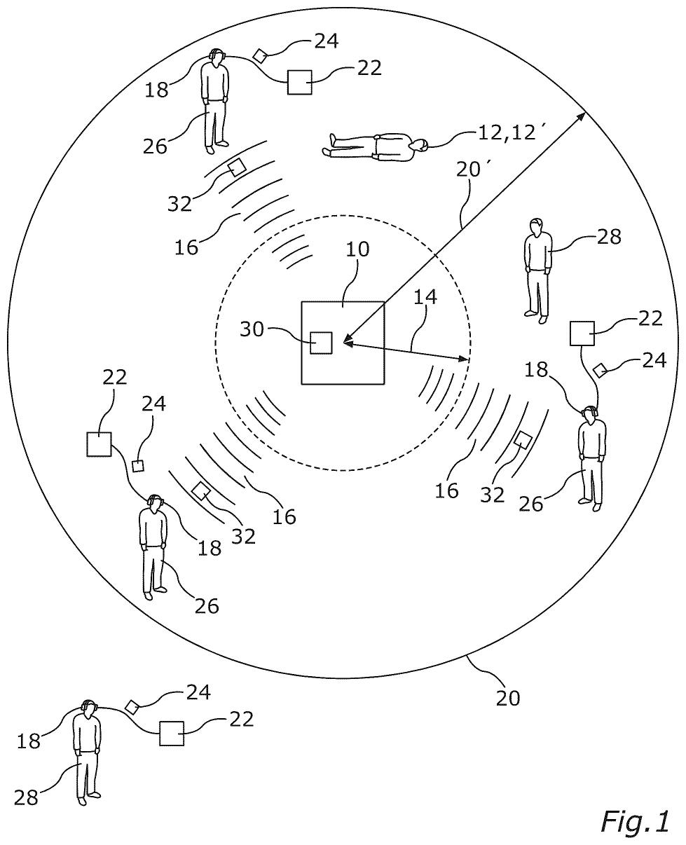

FIG. 1 shows, by way of example, a vehicle 10 that is involved in an emergency event. The emergency event may be for example an accident, in particular an accident in which at least one person 12 involved in the emergency event is involved. By way of example, a person involved in the emergency event may suffer at least one injury to their body and/or their health on account of the emergency event. In particular, this may be an accident in which the person 12 involved in the emergency event is at a greater distance from the vehicle 10 after the accident than before it. The vehicle may be for example a single-track motor vehicle, for example a motorcycle, a car, a jet ski, a trike or a quad bike. In addition or as an alternative, the emergency event may be an accident involving a person doing work, who in this case is then the at least one person involved in the emergency event, for example an agricultural and/or forestry worker who requires a vehicle 10 for work and/or moves away from the vehicle 10 during work.

If an emergency event occurs, this may be detected as an emergency event in various ways. For instance, an accident detection system may be present in the vehicle 10 and detects an emergency event for example on the basis of at least one sensor in the vehicle and/or on the basis of at least one sensor in a mobile terminal, for example a smartphone and/or a smartwatch. Accident detection systems are known from the prior art. In addition or as an alternative thereto, an emergency event may be detected on the basis of a predefinable voice command. By way of example, a voice command may be predefined or selected by a person such that, when an emergency event occurs, this emergency event is able to be detected by outputting the predefinable voice command. In addition or as an alternative thereto, a predefinable signal, which has to be output for example continuously or at predefinable dead-man time intervals by a person, may signal the occurrence of an emergency event. This may be designed for example in the same way as a dead man's handle, such that an emergency event is assumed if the signal is absent.

In addition or as an alternative, the exceedance of a predefinable distance 14 between the vehicle 10 and a person 12′ associated with the vehicle may lead to an emergency event being assumed. By way of example, in the event of an accident between the vehicle 10 and the person 12 involved in the emergency event, who, before the emergency event, is a person 12′ associated with the vehicle, there may be a greater distance than during normal use of the vehicle 10. A greater distance than normal may for example be present at a distance of more than 1 m, in particular more than 2 m, particularly preferably more than 5 m from the vehicle 10. For example, the distance greater than the normal distance is greater than the predefinable distance 14. The distance between the person 12′ associated with the vehicle and the vehicle 10 may be determined for example using a transmitter and/or receiver that the person associated with the vehicle carries around and/or through a mechanical connection, for example a cable, between the vehicle 10 and the person 12′ associated with the vehicle. In addition, an acceleration sensor may for example be arranged on the person 12′ associated with the vehicle and/or the transmitter and/or receiver and/or the vehicle 10, such that it is possible to detect an emergency event through a measurement of the distance between the vehicle 10 and the person 12′ associated with the vehicle in combination with a detected change in acceleration that exceeds a predefinable value.

In the occurrence of an emergency event, a broadcast message 16 is transmitted to all audio output units 18 within a reception area 20, wherein the reception area 20 is the area within which an audio output unit 18 is located to receive the broadcast message 16. The reception area 20 may be characterized by a maximum distance 20′, such that any audio output unit 18 whose distance from the vehicle 10 is less than the maximum distance 20′ is located in the reception area 20. The distance may be given using a method known from the prior art, for example using channel sounding or using the received signal strength indicator (RSSI).

An audio output unit 18 may for example be understood to mean a headset, a loudspeaker and/or headphones. In particular, an audio output unit 18 is characterized in that it is able to emit auditory content via sound waves. Each audio output unit 18 is configured to receive auditory entertainment content 24 from a source 22. The auditory entertainment content 24 transmitted to different audio output units 18 may differ and/or come from different sources 22. This means that different audio output units 18 are able to render different auditory entertainment content 24. In particular, different audio output units 18 receive the auditory entertainment content from different sources. Each audio output unit 18 is characterized in that it comprises at least one broadcast radio receiver.

An audio output unit 18 may be assigned to at least one person 26, 28. A person 26, 28 assigned to an audio output unit 18 may pick up the sound waves emitted by the audio output unit 18, for example by virtue of the person wearing the headset or the headphones and/or being at a predefinable maximum distance from a loudspeaker. If the person 26, 28 assigned to the audio output unit is a person within the reception area 20, who may differ from the person 12 involved in the emergency event, this person is referred to as a recipient 26. People outside the reception area 20 and people without an audio output unit are referred to as non-recipients 28.

If an emergency event is detected, a central unit 30 located in the vehicle 10 receives a predefined emergency signal signaling the detection of an emergency event to the central unit 30. The central unit 30 may broadcast a trigger signal in response to the emergency signal, said trigger signal preferably being auditory and/or visual and/or haptic. This means that it may be for example a beep, the illumination of a light, the playback of a predefinable noise and/or predefinable words and/or a vibration. For example, the trigger signal is designed such that it is able to be picked up by a person within a predefinable trigger pick-up area. This means for example that the trigger signal has at least a predefinable volume and/or a predefinable brightness everywhere in the trigger pick-up area, this preferably being smaller than the reception area 20.

If a predefinable duration, for example 0 s, 2 s, 3 s, 5 s or 10 s, has elapsed following broadcasting of the trigger signal, or if no trigger signal is broadcast, the broadcast message 16 is broadcast by the central unit 30. This means that a radio connection is established between the central unit 30 and all audio output units 18 within the reception area 20. This may be achieved in each case by way of a radio connection between the central unit 30 and the respective broadcast radio receiver of the audio output unit 18. One preferred embodiment comprises the radio connection being a connection via Bluetooth LE. This in particular offers the advantage of already providing the technical capabilities for transmitting a signal to a large number of audio output units 18 within a reception area 20 without there having to have previously been a connection to the audio output units 18. In addition or as an alternative, the radio connection via Bluetooth LE is implemented independently of the mobile network. The preferred embodiment thus makes provision for the broadcast message 16 to be sent regardless of the presence of a mobile network, that is to say for no mobile coverage to be required and/or for the radio connection not to be set up via a mobile network. Provision may in particular be made for the radio connection to be established between the central unit 30 and the audio output units 18 only as a result of the emergency event. This means that, prior to the occurrence of the emergency event, there was no radio connection between the central unit 30 and the respective audio output unit 18, in particular all audio output units 18 in the reception area 20, preferably all audio output units 18 in the reception area 20, apart from the audio output unit 18 with which the at least one person 12 involved in the emergency event is associated.

Following the establishment of the radio connection between the central unit 30 and the respective audio output units 18, the broadcast message 16 is transmitted over this radio connection. This means that auditory content 32 is transmitted to the audio output units 18 in the reception area 20, wherein the auditory content 32 is rendered by the audio output units 18 in the reception area 20 at least via sound waves. This gives the at least one recipient 26 the possibility of picking up the auditory content 32. The auditory content 32 may for example comprise a predefinable text, for example a text saved by a person, in particular a person 12′ associated with the vehicle, prior to the emergency event, and/or audio signals from a microphone, in particular a microphone that picks up noise and/or speech from the at least one person 12 involved in the emergency event, and/or a predefinable tone and/or a predefinable sequence of tones.

For example, in particular when the auditory content 32 comprises a predefinable text and/or a predefinable tone and/or a predefinable sequence of tones, the broadcast message 16 is broadcast repeatedly. This means that the auditory content 32 is broadcast repeatedly at predefinable time intervals by the audio output units 18 in the reception area 20. As an alternative thereto, the broadcast message 16 is broadcast once, in particular when recordings of a microphone are involved and/or the auditory content renders noise and/or speech of the person 12 involved in the emergency event after the emergency event has occurred.

Provision may be made for the central unit 30 to interrupt or terminate the broadcasting of the broadcast message 16 upon a predefinable command. This means that, upon a predefinable command, which is for example a voice command or the actuation of a button or of a touch-sensitive panel, any further broadcasting of a broadcast message 16 configured to be broadcast repeatedly is interrupted at least for a predefinable period and/or the broadcasting of the broadcast message 16 is terminated or, for example, in the case of transmission of noise and/or voices received by a microphone via the broadcast message 16, this transmission is terminated at least for a predefinable period.

If at least parts of at least two broadcast messages 16 are received by the same audio output unit 18 at at least one time, that is to say if at least one second broadcast message 16 is received by the same audio output unit 18 at at least one time while at least one first broadcast message 16 is already being received, there being at least one time at which at least parts of the at least one first broadcast message 16 are received by the audio output unit 18, but no part of the at least one second broadcast message 16 has yet been received, that is to say the start of the at least one first broadcast message 16 has been received before the start of the at least one second broadcast message 16 by the audio output unit 18, provision may be made for the auditory content 32 of the at least one second broadcast message 16 to be stored in a memory of the audio output unit 18 and be rendered when the auditory content 32 of the at least one first broadcast message 16 has finished being rendered.

After the at least one audio output unit 18 has rendered the auditory content 32 of the broadcast message 16, provision may be made for the rendering of the respective entertainment content 24 received from the respective source 22 to be continued.

One particularly embodiment is set forth below.

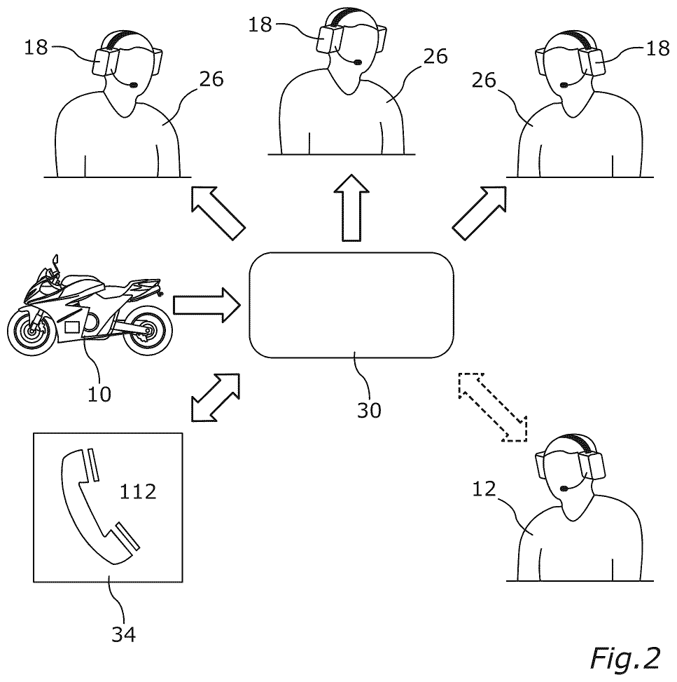

FIG. 2 shows a central unit 30, for example a connected infotainment box, which is able to implement at least one radio connection to at least one and/or different audio output units 18, for example to different headsets, preferably via Bluetooth LE Audio. The at least one radio connection may be of a private or public nature (broadcast). The central unit 30 may comprise a further unit capable of detecting an emergency event, for example an accident (for example via an accident detection system). When an emergency event is detected, the central unit 30 for example not only initiates an emergency call 34, but also sends a periodic or one-time broadcast message 16 over the radio connection. Each recipient 26, that is to say any person whose audio output unit 18 is located in the reception area 20 of the central unit 30 and/or within range of the radio connection from the central unit 30, is thereby able to receive the manual, partially automated or automated call for help. In particular, no mobile network connection is required for this purpose. One advantage that arises is that of shortening rescue times, since at least one recipient 26 is able to be alerted specifically to the emergency event and/or since accident sites that are difficult and/or impossible to see are easier to find. An additional or alternative advantage is the possibility of at least one recipient 26 providing faster assistance, for example in the form of first aid.

The central unit 30 may be integrated in a vehicle 10, for example in a quad bike, a small, low-complexity motorized vehicle, an off-road vehicle, an agricultural vehicle and/or a forestry vehicle (for example EU vehicle classes L, M, N, O, T, C). The connection between the vehicle and the central unit may be implemented via Bluetooth LE and/or CAN (Controller Area Network) and/or Bluetooth and/or Wi-Fi (Wireless Fidelity).

The central unit 30 may comprise at least one Bluetooth LE module, in particular a Bluetooth LE module in accordance with standard 5.2 or higher, which supports the optional feature LE Audio as a central and/or as a peripheral. This means that the Bluetooth LE module is able to broadcast and/or receive LE Audio signals. This may take place regardless of the presence of a mobile network.

One alternative application example is at least one person 12′ working in an area around the central unit 30, wherein the area is distinguished in that a predefinable signal, which is triggered by a person 12′ in the region, is received by the central unit 30. By way of example, the person 12′ may be wearing a headset on their head via which it is possible to communicate to the central unit 30, by way of a voice command, that an emergency event has occurred. This transmission of the emergency event may trigger the broadcasting of at least one broadcast message 16. It is thereby possible for example for people 12′ working in the area around the central unit 30 to make a call for help in the occurrence of an emergency event, for example in the event of an injury and/or an accident. By way of example, the person 12′ may be an agricultural or forestry worker.

Overall, the example shows how it is possible to provide a broadcast emergency call notification for headsets using Bluetooth LE Audio (for example on motorized two-wheeled vehicles).

1. A method, comprising:
sending at least one broadcast message via a central unit in a vehicle, wherein the broadcast message is intended for multiple audio output units, wherein at least two of the audio output units render different auditory entertainment content that is independent of the central unit, wherein the respective audio output unit that the method uses is one that comprises at least one broadcast radio receiver and that is configured to render auditory content, if this is picked up via the at least one broadcast receiver, via sound waves, and the central unit receives a predefined emergency signal signaling an emergency event, in response to which the central unit broadcasts at least one broadcast message via at least one radio connection to the respective broadcast radio receiver, wherein the broadcast message is distinguished in that it comprises the auditory content, and the broadcast message is received by all broadcast radio receivers within a reception area of the central unit, such that all audio output units within the reception area render the auditory content of the broadcast message.

2. The method as claimed in claim 1, wherein the central unit establishes the respective radio connection via Bluetooth LE, broadcasts the broadcast message via LE Audio in the form of LE Audio signals and the at least one broadcast receiver receives the LE Audio signals.

3. The method as claimed in claim 1, wherein the radio connection between the central unit and the respective broadcast receiver is established only in response to the detection of the emergency event.

4. The method as claimed in claim 1, wherein the respective emergency event is at least one of a group comprising:
an accident detection system detecting an accident,
the central unit picking up a predefinable voice command,
absence of transmission of a predefinable signal, wherein the predefinable signal has to be transmitted at predefinable dead-man time intervals and/or continuously to prevent triggering of the emergency signal, and
exceedance of a predefinable distance between a signal transmitter linked to a position of a person and the central unit.

5. The method as claimed in claim 1, wherein the broadcast message comprises at least one of a group, comprising:
predefinable text,
audio signals from a microphone connected to the central unit, and
a predefinable tone or a predefinable sequence of tones.

6. The method as claimed in claim 1, wherein the central unit broadcasts the broadcast message once or periodically at a predefinable time interval, wherein the central unit interrupts or terminates the broadcasting of the broadcast message upon a predefinable command.

7. The method as claimed in claim 1, wherein the broadcast message is broadcast regardless of the presence of a mobile network.

8. The method as claimed in claim 1, wherein when the emergency signal is picked up by the central unit, the central unit outputs an auditory and/or haptic and/or visual trigger signal, wherein the trigger signal is configured to be picked up by a person in a trigger pick-up area, wherein the trigger pick-up area is smaller than the reception area, and the broadcast message is broadcast by the central pick-up unit only after a predefinable duration from the outputting of the trigger signal.

9. The method as claimed in claim 1, wherein the respective audio output unit comprises a memory that stores a second broadcast message when at least part of a first broadcast message and at least part of the second broadcast message is received at the same time by the at least one broadcast receiver, wherein the start of the second broadcast message is received at a time after the start of the first broadcast message and the stored second broadcast message is rendered after the end of the first broadcast message.

10. A central unit, the central unit being configured to perform operations comprising:
sending at least one broadcast message via a central unit in a vehicle, wherein the broadcast message is intended for multiple audio output units, wherein at least two of the audio output units render different auditory entertainment content that is independent of the central unit, wherein the respective audio output unit that the method uses is one that comprises at least one broadcast radio receiver and that is configured to render auditory content, if this is picked up via the at least one broadcast receiver, via sound waves, and the central unit receives a predefined emergency signal signaling an emergency event, in response to which the central unit broadcasts at least one broadcast message via at least one radio connection to the respective broadcast radio receiver, wherein the broadcast message is distinguished in that it comprises the auditory content, and the broadcast message is received by all broadcast radio receivers within a reception area of the central unit, such that all audio output units within the reception area render the auditory content of the broadcast message.

11. A vehicle, comprising:
at least one central unit, the at least one central unit being configured to perform operations comprising:
sending at least one broadcast message via a central unit in a vehicle, wherein the broadcast message is intended for multiple audio output units, wherein at least two of the audio output units render different auditory entertainment content that is independent of the central unit, wherein the respective audio output unit that the method uses is one that comprises at least one broadcast radio receiver and that is configured to render auditory content, if this is picked up via the at least one broadcast receiver, via sound waves, and the central unit receives a predefined emergency signal signaling an emergency event, in response to which the central unit broadcasts at least one broadcast message via at least one radio connection to the respective broadcast radio receiver, wherein the broadcast message is distinguished in that it comprises the auditory content, and the broadcast message is received by all broadcast radio receivers within a reception area of the central unit, such that all audio output units within the reception area render the auditory content of the broadcast message.
